(19) United States
(12) Patent Application Publication
(10) Pub. No.: US 2012/0011370 A1
(43) Pub. Date: Jan. 12, 2012

(54) PERSONAL IDENTIFICATION CODE ENTRY DEVICE AND METHOD THEREFOR

(76) Inventor: David John DUKE, Corby (GB)

(21) Appl. No.: 12/830,789

(22) Filed: Jul. 6, 2010

(51) Int. Cl. G06F 21/24

(52) U.S. Cl. 713/183

(57) ABSTRACT

A data entry device for entering characters of a personal identification code comprising a pattern of chambers containing a character of a personal identification code which is required to be selected, said chambers being displayed in different lines on said pattern and each chamber containing a character therein; and a plurality of selection buttons each selection button being capable of selecting a sole line of said lines on said pattern.

This invention relates to a device or method for entering a personal identification code in order to obtain authorization in order to gain access to a protected resources, information or service.

Such devices are well known, in particular those that use Personal Identification Numbers (PIN), but suffer from the disadvantages that unscrupulous or unauthorized persons can obtain a users authentication code, as it is being correctly entered into existing systems. The code can be obtained by several methods including but not limited to; looking over the shoulder of the user or spying remotely with the use of visual aids.

Desirably the present invention stops phishing websites, hackers or unauthorized people from obtaining your passwords by reading the network data stream (as the password entered is never sent across the internet to an authentication end point ‘by itself’), watching, collecting or recording your password entry either once (e.g. an unauthorized person could surreptitiously watch you enter your password and obtain it that way) or multiple times (e.g. an unauthorized person could record multiple entries of one or more characters of your password and then attempt to calculate the entire password). This invention would desirably prevent unauthorized people from using recorded key presses, screen data, fake login screens, character enumeration mouse clicks and sniffing/reading data over a network, all of which give them the ability to steal your password.

In one aspect the subject invention provides a data entry device for entering characters of a personal identification code comprising
a pattern of chambers containing a character (e.g. letter, number, image, or other character) of a personal identification code which is required to be selected, said chambers being displayed in different lines on said pattern and each chamber containing a character (e.g. letter, number, image, or other character) therein;
and a plurality of selection buttons each selection button being capable of selecting a sole line of said lines on said pattern.

In another aspect the subject invention provides a method of generating a data entry device for entering characters of a personal identification code comprising the steps of:
generating a pattern of chambers containing a character of a personal identification code which is required to be selected, said chambers being displayed in different lines on said pattern and each chamber containing a character therein;
and providing a plurality of selection buttons each selection button being capable of selecting a sole line of said lines on said pattern.

One or some of the characters contained in the chambers can be blank or a hole or holes. Preferably a blank chamber between filled chambers could break the line (i.e. a blank chamber between filled chambers can discontinue a line). The character of said personal identification code or said character contained in each of said chambers can include any symbol.

Preferably said lines can be at any angle with respect to the horizontal. More preferably said selection buttons are positioned to be capable of selecting at least three lines which are at different angles to the horizontal. Yet more preferably there is further provided a means for re-positioning said characters in said chambers in a random manner. Even more preferably there is further provided a means for re-generating characters in said chambers in a random manner. Yet more preferably more than one same characters are contained in said chambers of the pattern. Even more preferably at least two said selection buttons are capable of selecting different lines containing the same chamber.

Preferably a matrix or pattern is generated, which may or may not be square. A non square matrix or pattern is more secure as it cannot be easily rotated on fake login sites or devices. The character in each chamber includes a randomly generated image, letter, number or other character. Preferably the pattern comprises more than one same character.

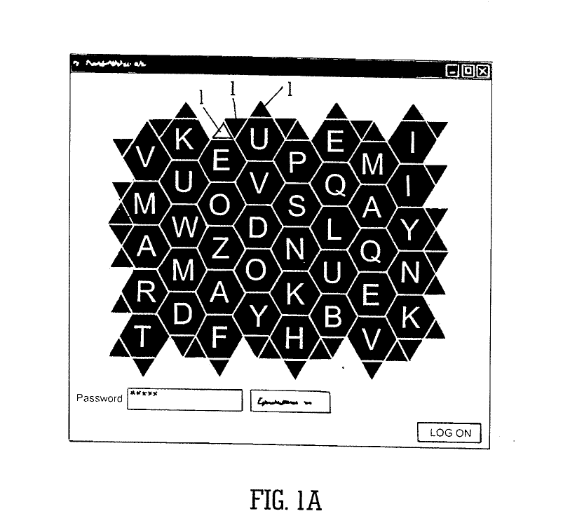

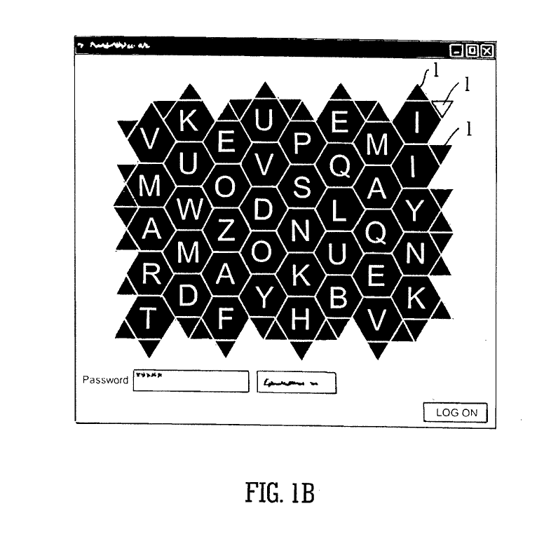

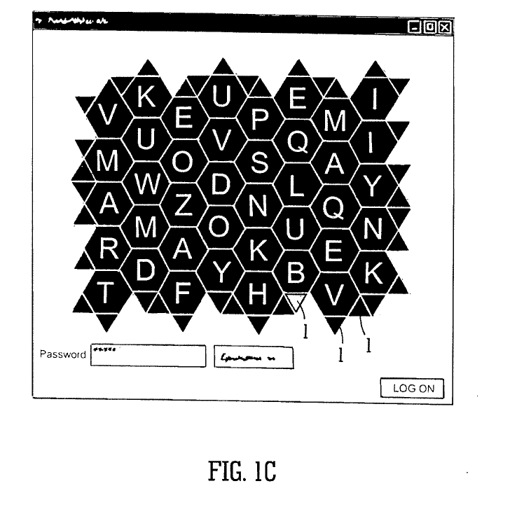

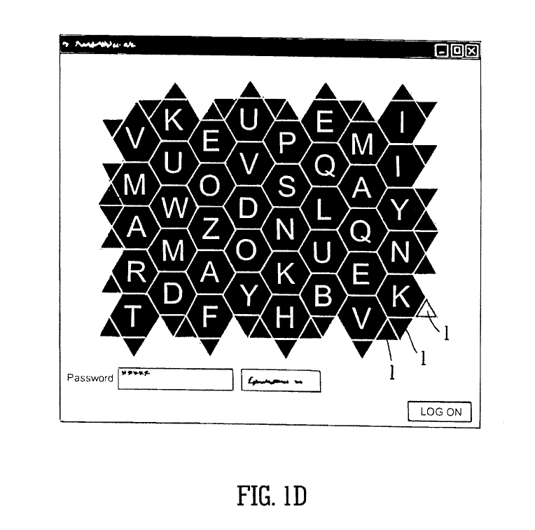

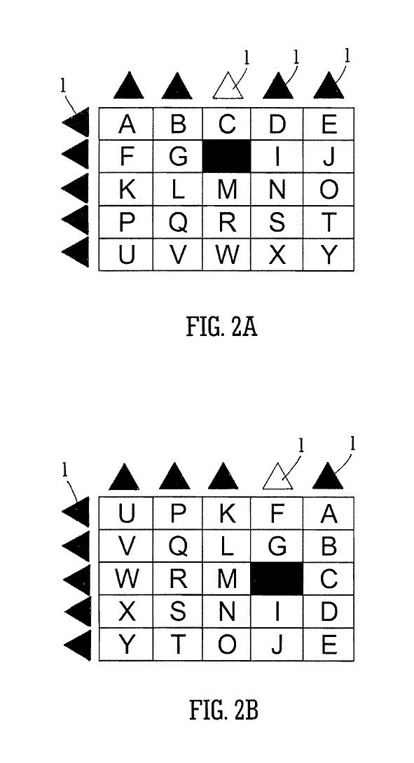

Preferred embodiments of the invention are described below by way of example only with reference to FIGS. 1A-2B the accompanying drawings wherein:

FIG. 1A-FIG. 1D describe a first embodiment according to the present invention;

FIG. 2A-FIG. 2B describe a second embodiment according to the present invention.

FIG. 1 shows a pattern of chambers containing a character of a personal identification code which is required to be selected, said chambers being displayed in different lines on said pattern and each chamber containing a symbol therein and a plurality of selection buttons 1 each selection button being capable of selecting a sole line of said lines on said pattern. Random numbers are generated once at the login process as shown in FIG. 1A. Preferably they are moved around or regenerated each time a selection is made. This prevents a hacker from building a fake login screen with the known letters, and prevents him from changing these letters to different positions to work out the password. This also prevents the hacker from counting the letters to work out the password based on the number of occurrences of the password in the matrix.

As shown the matrix or pattern is surrounded by selection buttons to select the line in which the characters of the password exists. When the user is required to enter his password he inputs individual characters of his password by selecting a line for each character of the password in the order in which they appear in the password. Mixed characters which are present in the line which is selected by the user are sent to a server across the internet. The server computer can then match the known password against the data that has been collected from the characters in the selected lines. The user's actual password is never sent for authentication. Instead it is present in a mixed jumble of letters, numbers, images or other characters, which can not be figured out by a “man in the middle” attack as there is no encrypted password being sent. In addition multiple passwords can be used for the same log-in which would make breaking the password more difficult as passwords could be completely different. For example a password could be a colour or a day of the week and a user could use any of them to log-in. Each time the user logs in, the letters, numbers or other symbols in the matrix or pattern appear in different positions. As the original random letters generated are random a symbol may appear several times in several positions, and some letters and/or numbers may not even be present.

In FIGS. 1A-1D the password to be entered is ‘fred’. You can click any selection button 1 (selection buttons selected being shown by white color) which has the letter “F” somewhere in the line. In this example you can see that the row “EOZAF” has been selected which contains the first letter of the password “F” The computer would see that you had the “f’ as the first letter of your password and then discard the other letters in the row. For the second letter “r”, the row “IMQSDZMIR” has been selected, which contains the letter “R” as shown in FIG. 1B. Alternatively the row “VMART” can be selected, which contains the letter “R”.

FIG. 1C shows the selection “EQLUB” which contains “E” and as shown in FIG. 1D the last selection “VUODNIJEK” contains the last letter “D”.

In FIGS. 1A-1D the outside triangle markers (highlighted in white) show the mouse clicks to select the rows or lines that the password characters exist in. FIG. 1A shows the ‘F’. FIG. 1B shows the ‘R’. FIG. 1C shows the ‘E’. FIG. 1D shows the ‘D’. The string collected by the login process would be EOZAF-IMQSDZMR-EQLUB-VUODNUEK.

The system knows the user's password and the system can therefore compare the first character in the user's password with the first five characters in the above string collected by the login process to check whether the string contains the first character of the user's password and can then compare the second character in the user's password with the next eight characters in the above string and so on. Thereby all the user's line selections containing all his password characters are collected before the confirming is performed. Alternatively the first character in the password can be confirmed before a user selects a line containing his second password character and so on.

In this embodiment the chamber is shown with hexagonal shape. Using different shapes having more sides will significantly increase the difficulty for the password to be compromised.

In this embodiment the letters on the matrix or pattern are static to simplify the description process. However to be more secure the letters are moved or regenerated every time a line is selected.

The next time you logged in, the letters, numbers or other symbols would all be in different place on the matrix or pattern and would also be different and may not contain all the letters in the alphabet, some could be duplicated, this adds to the security of the matrix or pattern .

This invention is designed to stop internet phishing sites (the theft of passwords from a fake site or fake login screen), or unauthorized people working out the password from a matrix based password entry system.

FIG. 2A-FIG. 2B shows a second embodiment of the invention. In this embodiment the chamber is shown with square shape. This embodiment is less preferred as a fixed width and height matrix based system having lines selected by selection buttons orthogonal to each other can be compromised by a fake login screen which rotates the matrix 90 degrees. Then asking for the password again. This enables unauthorized peoples to directly identify the user's password and makes normal matrix based password entry insecure.

The more preferred embodiment shown in FIGS. 1A-1D overcomes this problem with two preferred features first that the pattern or matrix has lines selected by selection buttons which are not orthogonal to each other and second that the letters are moved around after each line selection.

Although the letters in the alphabet shown on FIG. 2A or 2B are all different from each other or unique (each letter of the alphabet exists only once), in more preferred embodiments the letters in the alphabet are not all different from each other. This is more preferred as it makes it less easy for unauthorized people to detect the specific character if an unauthorized person captures the password entry multiple times.

1. A system that enables a user to securely enter a password in a public place or over the internet where the data entry process can be observed or recorded.

2. A system according to claim 1, which prevents unauthorized peoples from obtaining passwords entered using this system and subsequently working out the password from the collected data.

3. A system according to claim 2, which has a unique data entry format consisting of a non square matrix which contains multiple references to the same data in more than two dimensions therefore making it harder to guess the password entered.

4. A system according to claim 3, which stops unauthorized peoples from “capturing” a user's password by logging keys pressed on a keyboard.

5. A system according to claim 4, which stops unauthorized peoples from gaining a user's password by capturing images or video from a screen as the password is being entered.

6. A system according to claim 5, which stops unauthorized peoples from gaining a user's password by capturing mouse clicks or mouse positions.

7. A system according to claim 6, which prevents unscrupulous users building dummy screens to collect password information

8. A system according to claim 7, which prevents unscrupulous users rotating password data entry screens to workout where letters in the password are.

9. A system according to claim 8, which uses a three or more dimensional matrix, allowing password sections in three or more different directions, not just horizontal and vertical.

10. A system according to claim 9, which uses multiple sided objects in a matrix to increase the difficulty to work out the letters selected.

11. A system according to claim 10, to prevent automated phishing (data capture) sites from collecting password information entered automatically in one go.

12. A data entry device for entering characters of a personal identification code comprising
a pattern of chambers containing a character of a personal identification code which is required to be selected, said chambers being displayed in different lines on said pattern and each chamber containing a character therein; and
a plurality of selection buttons each selection button being capable of selecting a sole line of said lines on said pattern.

13. A data entry device according to claim 12, wherein said lines can be at any angle with respect to the horizontal.

14. A data entry device according to claim 12, wherein said selection buttons are positioned to be capable of selecting at least three lines which are at different angles to the horizontal.

15. A data entry device according to claim 12, said data entry device further comprising a means for repositioning said characters in said chambers in a random manner.

16. A data entry device according to claim 12, said data entry device further comprising a means for regenerating said characters in said chambers in a random manner.

17. A data entry device according to claim 12, wherein more than one same characters are contained in said chambers of the pattern.

18. A data entry device according to claim 12, wherein at least two said selection buttons are capable of selecting different lines containing the same chamber.

19. A method of generating a data entry device for entering characters of a personal identification code comprising the steps of:
generating a pattern of chambers containing a character of a personal identification code which is required to be selected, said chambers being displayed in different lines on said pattern and each chamber containing a character therein; and
providing a plurality of selection buttons each selection button being capable of selecting a sole line of said lines on said pattern.

20. A method according to claim 19, wherein said lines can be at any angle with respect to the horizontal.

21. A method according to claim 19, wherein said selection buttons are positioned to be capable of selecting at least three lines which are at different angles to the horizontal.

22. A data entry device according to claim 19, said method further comprises a step of repositioning said characters in said chambers in a random manner.

23. A data entry device according to claim 19, said method further comprises a step of regenerating characters in said chambers in a random manner.

24. A data entry device according to claim 19, wherein more than one same characters are contained in said chambers of the pattern.

25. A data entry device according to claim 19, wherein at least two said selection buttons are capable of selecting different lines containing the same chamber.
